(19) United States
(12) Patent Application Publication
(10) Pub. No.: US 2024/0377507 A1
(43) Pub. Date: Nov. 14, 2024

(54) RADAR DEVICE AND OPERATION METHOD THEREOF

(71) Applicant: Electronics and Telecommunications Research Institute, Daejeon (KR)

(72) Inventors: Seong Mo Park, Daejeon (KR); Kyung Hwan Park, Daejeon (KR); Pil Jae Park, Daejeon (KR); Byounggun Choi, Daejeon (KR); Jang Hong Choi, Daejeon (KR)

(73) Assignee: Electronics and Telecommunications Research Institute, Daejeon (KR)

(21) Appl. No.: 18/656,966

(22) Filed: May 7, 2024

(30) Foreign Application Priority Data
May 8, 2023 (KR) 10-2023-0059380
May 7, 2024 (KR) 10-2024-0059608

(51) Int. Cl. G01S 7/288; G01S 7/35; G01S 13/87

(52) U.S. Cl. CPC G01S 7/2886; G01S 7/358; G01S 13/878

(57) ABSTRACT

Disclosed is a radar device which includes a transmission circuit that emits a first transmission signal and a second transmission signal, and a reception circuit that receives a first reception signal associated with the first transmission signal and a second reception signal associated with the second transmission signal, converts the first reception signal into first data, and converts the second reception signal into second data.

### CROSS-REFERENCE TO RELATED APPLICATIONS

This application claims priority under 35 U.S.C. § 119 to Korean Patent Application No. 10-2023-0059380 filed on May 8, 2023, and Korean Patent Application No. 10-2024-0059608 filed on May 7, 2024 in the Korean Intellectual Property Office, the disclosures of which are incorporated by reference herein in their entireties.

### BACKGROUND

Embodiments of the present disclosure described herein relate to a radar device and an operation method thereof, and more particularly, relate to a radar device for improving coherence of distributed radars and an operation method thereof.

Nowadays, there are developed various radar-based technologies for human detection in a wide-area disaster environment. One of the technologies is a distributed radar coherence technology using a distributed radar system.

The distributed radar system detects a common target by using a plurality of radars disposed at different locations. The distributed radar system may generate a high-resolution image from data collected through the plurality of radars by using the distributed radar coherence technology. As such, the distributed radar system is used in various fields such as military, aerospace, and disaster environmental rescue. However, the distributed radar system is underutilized due to a limited driving method thereof. Accordingly, to increase the utilization of the distributed radar system, there is required a method for improving coherence of the distributed radar system.

### SUMMARY

Embodiments of the present disclosure provide a radar device for improving coherence of distributed radars and an operating method thereof.

According to an embodiment, a radar device includes a transmission circuit that emits a first transmission signal and a second transmission signal, and a reception circuit that receives a first reception signal associated with the first transmission signal and a second reception signal associated with the second transmission signal, converts the first reception signal into first data, and converts the second reception signal into second data. The reception circuit synchronizes a phase of the second reception signal with a phase of the first reception signal based on the first data and the second data and outputs a first compensation signal. The reception circuit includes a pre-processing circuit that generates first encoding data based on the first data, generates second encoding data based on the second data, and generates pre-processed data based on the first encoding data and the second encoding data, a phase compensation circuit that generates compensation data based on the pre-processed data and a phase compensation table, and a digital-to-analog converter that outputs the first compensation signal being an analog signal, based on the compensation data.

As an example, the pre-processing circuit includes a quantizer that generates first quantized data and second quantized data based on the first data and the second data, an encoder that generates the first encoding data and the second encoding data based on the first quantized data and the second quantized data, and a subtracter that generates the pre-processed data by performing a subtraction operation on the first encoding data and the second encoding data. A first portion of the pre-processed data is coarse phase difference data, and a second portion of the pre-processed data is fine phase difference data.

As an example, the subtracter generates first pre-processed data corresponding to a first time point and second pre-processed data corresponding to a second time point before the first time point, and the subtracter outputs first fine phase difference data being a second portion of the first pre-processed data and second fine phase difference data being a second portion of the second pre-processed data to the phase compensation circuit.

As an example, the phase compensation circuit includes a comparator that performs a comparison operation on the first fine phase difference data and the second fine phase difference data and generates first phase difference data associated with the first time point, and a compensator that generates first compensation data associated with the first time point, based on the first phase difference data, first coarse data being a first portion of the first pre-processed data, and the phase compensation table.

As an example, the compensator combines the first phase difference data and the first coarse data, search the phase compensation table for the combined data, and generates the first compensation data based on the found result.

As an example, the compensator generates second compensation data associated with a third time point after the first time point, and the digital-to-analog converter outputs the first compensation signal, based on the first compensation data and the second compensation data.

As an example, the phase compensation circuit further includes an error corrector that corrects an error of the first compensation data.

As an example, the error corrector compares the error and a preset threshold value, and when the comparison result indicates that the error is within the threshold value, the error corrector corrects the error.

As an example, the reception circuit includes a control circuit that controls operations of the pre-processing circuit and the phase compensation circuit. When the comparison result indicates that the error exceeds the threshold value, the error corrector transmits a result signal to the control circuit, and the control circuit receives the result signal and then transmits a re-execution signal to the pre-processing circuit.

As an example, the pre-processing circuit receives the re-execution signal and then changes the number of bits of the first encoding data and the second encoding data.

As an example, the phase compensation table is stored in a read only memory (ROM) included in the reception circuit.

As an example, the second reception signal is one of a pulse signal, a continuous wave signal, and a frequency modulation continuous wave signal.

As an example, the transmission circuit emits a third transmission signal, and the reception circuit receives a third reception signal associated with the third transmission signal, converts the third reception signal into third data, and synchronize a phase of the third reception signal with the phase of the first reception signal based on the first data and the third data to output a second compensation signal.

As an example, the second reception signal and the third reception signal are two signals different from each other from among a pulse signal, a continuous wave signal, and a frequency modulation continuous wave signal.

According to an embodiment, an operation method of a radar device includes receiving a first reception signal associated with a first transmission signal and a second reception signal associated with a second transmission signal, converting the first reception signal and the second reception signal into first data and second data, generating first encoding data and second encoding data based on the first data and the second data, generating pre-processed data based on the first encoding data and the second encoding data, generating compensation data based on the pre-processed data and a phase compensation table, and outputting a first compensation signal based on the compensation data.

As an example, the generating of the first encoding data and the second encoding data includes generating first quantized data and second quantized data based on the first data and the second data. The generating of the pre-processed data includes performing a subtraction operation on the first encoding data and the second encoding data. A first portion of the pre-processed data is coarse phase difference data, and a second portion of the pre-processed data is fine phase difference data.

As an example, the generating of the pre-processed data includes generating first pre-processed data corresponding to a first time point, and generating second pre-processed data corresponding to a second time point before the first time point. The generating of the compensation data includes generating first phase difference data associated with the first time point by performing a comparison operation on first fine phase difference data being a second portion of the first pre-processed data and second fine phase difference data being a second portion of the second pre-processed data, and generating first compensation data associated with the first time point, based on the first phase difference data, first coarse data being a first portion of the first pre-processed data, and the phase compensation table.

As an example, the generating of the first compensation data includes combining the first phase difference data and the first coarse data, searching the phase compensation table for the combined data, and generating the first compensation data based on the found result.

As an example, the generating of the compensation data includes

generating second compensation data associated with a third time point after the first time point, and the outputting of the first compensation signal includes outputting the first compensation signal, based on the first compensation data and the second compensation data.

As an example, the method further includes correcting an error of the first compensation data.

### BRIEF DESCRIPTION OF THE FIGURES

The above and other objects and features of the present disclosure will become apparent by describing in detail embodiments thereof with reference to the accompanying drawings.

FIG. 1 illustrates a radar device according to an embodiment of the present disclosure.

FIG. 2 illustrates a radar device according to an embodiment of the present disclosure.

FIG. 3 illustrates a phase synchronization circuit according to an embodiment of the present disclosure.

FIG. 4 illustrates an example of a pre-processing circuit of FIG. 3.

FIGS. 5A and 5B are diagrams for describing pre-processed data, according to an embodiment of the present disclosure.

FIG. 6 illustrates an example of a phase compensation circuit of FIG. 3.

FIG. 7 illustrates another example of a phase compensation circuit of FIG. 3.

FIG. 8 illustrates a digital-to-analog converter of FIG. 3.

FIG. 9 illustrates an example of an operation of a radar device, according to an embodiment of the present disclosure.

### DETAILED DESCRIPTION

Below, embodiments of the present disclosure will be described in detail and clearly to such an extent that an ordinary one in the art easily carries out the present disclosure.

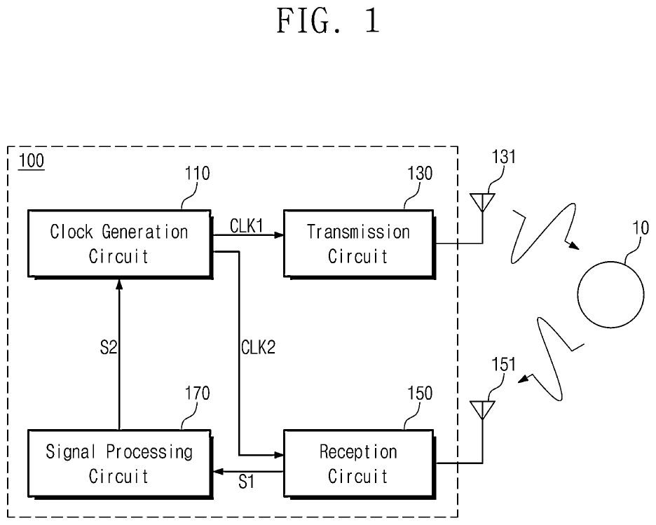

FIG. 1 illustrates a radar device according to an embodiment of the present disclosure. Referring to FIG. 1, a radar device 100 may include a clock generation circuit 110, a transmission circuit 130, a reception circuit 150, and a signal processing circuit 170. In an embodiment, the radar device 100 may be included in a system for human rescue in a disaster environment.

The clock generation circuit 110 may generate a clock (hereinafter referred to as a “first transmission clock”) CLK1 which is used for the transmission circuit 130 to generate a transmission signal. The clock generation circuit 110 may generate a clock (hereinafter referred to as a “first reception clock”) CLK2 which is used for the reception circuit 150 to process a signal. The clock generation circuit 110 may output the transmission clock CLK1 to the transmission circuit 130 and may output the reception clock CLK2 to the reception circuit 150.

Each of the transmission clock CLK1 and the reception clock CLK2 may have a logical low value or a logical high value periodically. Each of the logical high value and the logical low value of the transmission clock CLK1 and the reception clock CLK2 may correspond to a magnitude of a specific voltage.

After a delay passes from a point in time when the transmission clock CLK1 is output to the transmission circuit 130, the clock generation circuit 110 may output the reception clock CLK2 to the reception circuit 130. The delay may be associated with a detection distance of the radar device 100. The clock generation circuit 110 may adjust the detection distance of the radar device 100 by adjusting the delay. For example, as the delay becomes longer, the detection distance of the radar device 100 may become longer. As the delay becomes shorter, the detection distance of the radar device 100 may become shorter.

In an embodiment, the clock generation circuit 110 may include a delay locked loop DLL to output the transmission clock CLK1 and the reception clock CLK2 based on the delay. The delay locked loop DLL may include a multi-stage voltage controlled delay line VCDL. The multi-stage voltage controlled delay line VCDL may generate clocks with various delays by using a reference clock CLK. For example, the multi-stage voltage controlled delay line VCDL may generate clocks which are delayed as much as a time, and the time may correspond to one of equal parts obtained through the division of the period of the reference clock CLK. The delay locked loop DLL may generate the transmission clock CLK1 by using clocks generated by the multi-stage voltage controlled delay line VCDL. Also, the delay locked loop DLL may generate the reception clock CLK2 delayed with respect to the transmission clock CLK1. Accordingly, the clock generation circuit 110 may adjust the delay by using the clocks generated by the multi-stage voltage controlled delay line VCDL.

The transmission circuit 130 may receive the transmission clock CLK1 from the clock generation circuit 110. The transmission circuit 130 may emit the transmission signal to a target 10, based on the transmission clock CLK1. For example, the transmission circuit 130 may emit the transmission signal to the target 10 through a transmitting antenna 131 by using the transmission clock CLK1 as a transmission trigger signal.

The reception circuit 150 may receive the reception clock CLK2 from the clock generation circuit 110. The reception circuit 150 may receive an echo signal (or a reception signal) reflected from the target 10, based on the reception clock CLK2. For example, the reception circuit 150 may receive the echo signal through a receiving antenna 151, based on the reception clock CLK2. The echo signal may be associated with the transmission signal and may indicate information associated with a location, a speed, etc. of the target 10. The reception circuit 150 may process the echo signal and may output a signal S1.

The signal processing circuit 170 may receive the signal S1 from the reception circuit 150. The signal processing circuit 170 may calculate values associated with the target 10, based on the signal S1. For example, the signal processing circuit 170 may calculate the location and the speed of the target 10, based on the signal S1. The signal processing circuit 170 may output a signal S2 for controlling a delay between the transmission clock CLK1 and the reception clock CLK2 to the clock generation circuit 110.

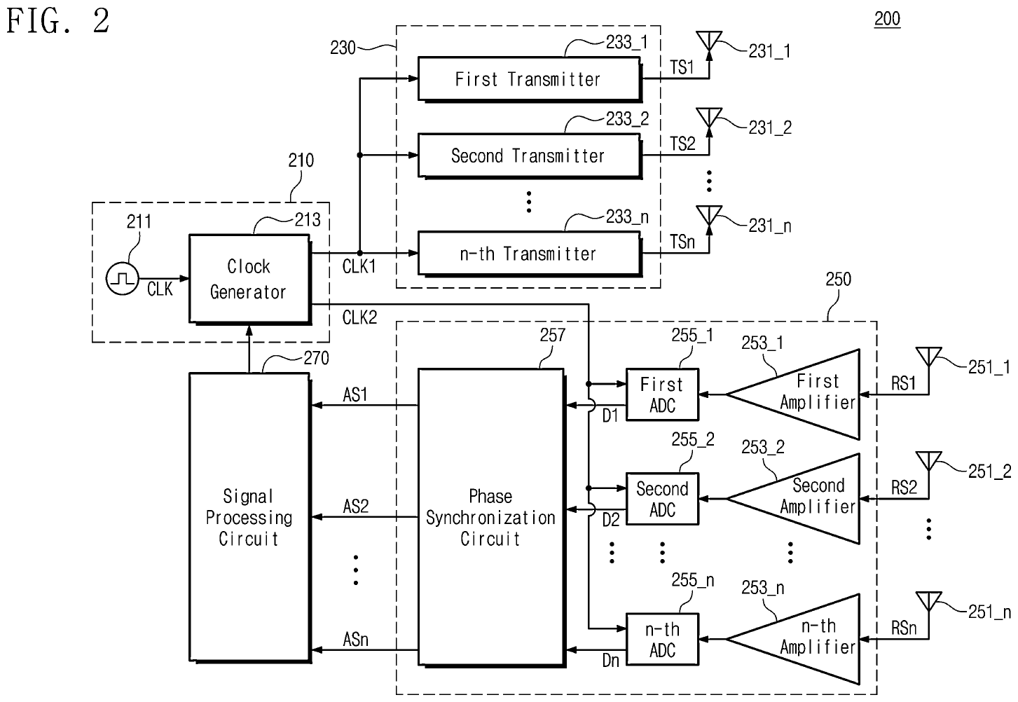

FIG. 2 illustrates a radar device according to an embodiment of the present disclosure. Referring to FIG. 2, a radar device 200 may include a clock generation circuit 210, a transmission circuit 230, a reception circuit 250, and a signal processing circuit 270.

The clock generation circuit 210 may include a reference clock generator 211 and a clock generator 213. The reference clock generator 211 may generate the reference clock CLK and may output the reference clock CLK to the clock generator 213.

The clock generator 213 may generate the transmission clock CLK1 and may output the transmission clock CLK1 to the transmission circuit 230. The clock generator 213 may generate the reception clock CLK2 and may output the reception clock CLK2 to the reception circuit 250.

The transmission circuit 230 may include first to n-th transmitters 233_1 to 233_n. Each of the first to n-th transmitters 233_1 to 233_n may receive the transmission clock CLK1 from the clock generator 213. The first to n-th transmitters 233_1 to 233_n may emit first to n-th transmission signals TS1 to TSn through first to n-th transmitting antennas 231_1 to 231_n, based on the transmission clock CLK1. For example, the first transmitter 233_1 may emit the first transmission signal TS1 through the first transmitting antenna 231_1, the second transmitter 233_2 may emit the second transmission signal TS2 through the second transmitting antenna 231_2, and the n-th transmitter 233_n may emit the n-th transmission signal TSn through the n-th transmitting antenna 231_n.

An example in which the first to n-th transmitters 233_1 to 233_n receive the same transmission clock CLK1 is illustrated in FIG. 2, but the present disclosure is not limited thereto. For example, each of the first to n-th transmitters 233_1 to 233_n may receive two or more different transmission clocks.

In an embodiment, the first to n-th transmission signals TS1 to TSn may be signals of various shapes. For example, each of the first to n-th transmission signals TS1 to TSn may be one of a pulse signal, a continuous wave (CW) signal, a frequency modulation continuous wave (FMCW) signal. However, the present disclosure is limited thereto.

In an embodiment, the first transmission signal TS1 may be a reference transmission signal which is used as a reference of the second to n-th transmission signals TS2 to TSn.

The reception circuit 250 may include first to n-th analog-to-digital converters 255_1 to 255_n and the first to n-th amplifiers 253_1 to 253_n. The first to n-th amplifiers 253_1 to 253_n may receive first to n-th echo signals RS1 to RSn through first to n-th receiving antennas 251_1 to 251_n. For example, the first amplifier 253_1 may receive the first echo signal RS1 through the first receiving antenna 251_1, the second amplifier 253_2 may receive the second echo signal RS2 through the second receiving antenna 251_2, and the n-th amplifier 253_n may receive the n-th echo signal RSn through the n-th receiving antenna 251_n.

In an embodiment, the first to n-th echo signals RS1 to RSn may be respectively associated with the first to n-th transmission signals TS1 to TSn. For example, the first echo signal RS1 may be associated with the first transmission signal TS1, the second echo signal RS2 may be associated with the second transmission signal TS2, and the n-th echo signal RSn may be associated with the n-th transmission signal TSn.

In an embodiment, the first echo signal RS1 may be a reference echo signal which is used as a reference for synchronizing phases of the second to n-th echo signals RS2 to RSn.

The first to n-th amplifiers 253_1 to 253_n may amplify the first to n-th echo signals RS1 to RSn. For example, the first amplifier 253_1 may amplify the first echo signal RS1, the second amplify 253_2 may amplify the second echo signal RS2, and the n-th amplifier 253_n may amplify the n-th echo signal RSn.

The first to n-th analog-to-digital converters 255_1 to 255_n may receive the amplified signals from the first to n-th amplifiers 253_1 to 253_n. The first to n-th analog-to-digital converters 255_1 to 255_n may convert the amplified signals into digital signals. For example, the first analog-to-digital converter 255_1 may convert the amplified signal received from the first amplifier 253_1 into first data D1, the second analog-to-digital converter 255_2 may convert the amplified signal received from the second amplifier 253_2 into second data D2, and the n-th analog-to-digital converter 255_n may convert the amplified signal received from the n-th amplifier 253_n into n-th data Dn. In other words, the first to n-th analog-to-digital converters 255_1 to 255_n may convert analog signals received from the first to n-th amplifiers 253_1 to 253_n into digital signals.

In an embodiment, the first to n-th analog-to-digital converters 255_1 to 255_n may perform sampling, quantization, and encoding for the amplified signals received from the first to n-th amplifiers 253_1 to 253_n so as to be converted into digital signals.

A phase synchronization circuit 257 may receive the first to n-th data D1 to Dn from the first to n-th analog-to-digital converters 255_1 to 255_n. The phase synchronization circuit 257 may process the first to n-th data D1 to Dn such that the phases of the first to n-th echo signals RS1 to RSn are synchronized. Alternatively, the phase synchronization circuit 257 may process the first to n-th data D1 to Dn such that the phases of the first to n-th data D1 to Dn are synchronized. The phase synchronization circuit 257 may output first to n-th analog signals AS1 to ASn as a result of processing the first to n-th data D1 to Dn.

In an embodiment, the first analog signal AS1 may be an analog signal obtained through the conversion of the first data D1.

In an embodiment, the second to n-th analog signals AS2 to ASn may be a result of processing the first to n-th data D1 to Dn such that the phase of each of the second to n-th echo signals RS2 to RSn is synchronized with the phase of the first echo signal RS1. For example, the second analog signal AS2 may be a result of processing the first and second data D1 and D2 such that the phase of the second echo signal RS2 is synchronized with the phase of the first echo signal RS1. For example, the n-th analog signal ASn may be a result of processing the first and n-th data D1 and Dn such that the phase of the n-th echo signal RSn is synchronized with the phase of the echo signal RS1. In other words, the second to n-th analog signals AS2 to ASn may be first to (n−1)-th compensation signals obtained by synchronizing the phases of the second to n-th echo signals RS2 to RSn with the phase of the first echo signal RS1.

An example in which the phase synchronization circuit 257 outputs the first to n-th analog signals AS1 to ASn to the signal processing circuit 270 is illustrated in FIG. 2, but the present disclosure is not limited thereto. For example, the phase synchronization circuit 257 may synchronize the phase of each of the second to n-th echo signals RS2 to RSn with the phase of the first echo signal RS1 and may output one analog signal.

The signal processing circuit 270 may receive the first to n-th analog signals AS1 to ASn from the phase synchronization circuit 257. The signal processing circuit 270 may calculate values associated with a target, based on the first to n-th analog signals AS1 to ASn. The signal processing circuit 270 may output a signal for controlling a delay between the transmission clock CLK1 and the reception clock CLK2 to the clock generation circuit 210.

An example in which the phase synchronization circuit 257 is included in the reception circuit 250 is illustrated in FIG. 2, but the present disclosure is not limited thereto. For example, the phase synchronization circuit 257 may be included in the signal processing circuit 270.

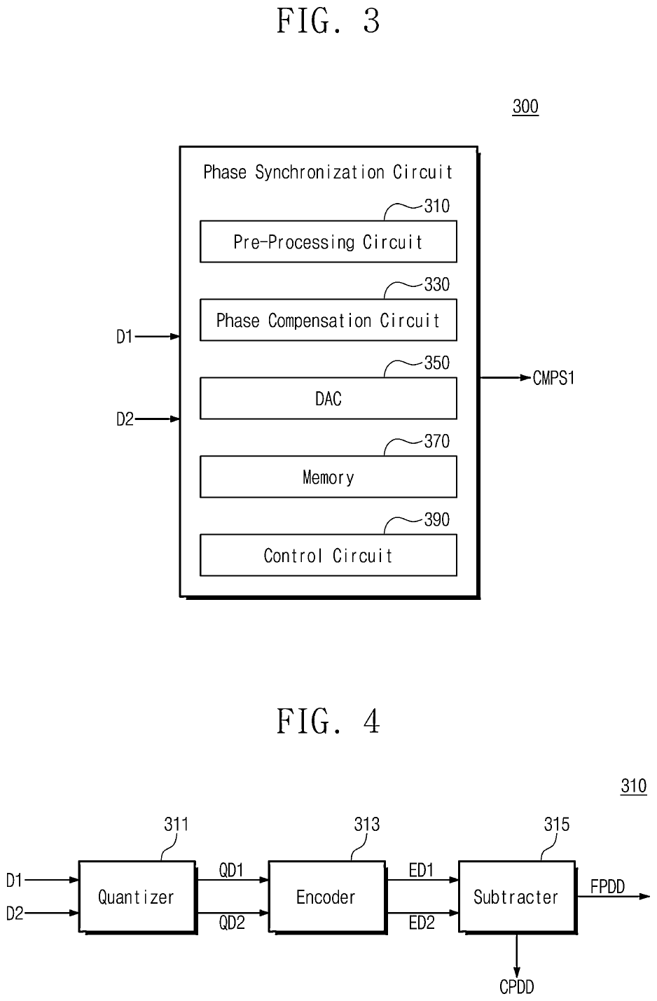

FIG. 3 illustrates a phase synchronization circuit according to an embodiment of the present disclosure. Referring to FIG. 3, a phase synchronization circuit 300 may receive the first and second data D1 and D2, and the phase synchronization circuit 300 may synchronize the phase of the second data D2 with the phase of the first data D1 based on the first and second data D1 and D2 and may generate a first compensation signal CMPS1. The first data D1 may be reference data which are used for phase compensation.

An example in which the phase synchronization circuit 300 receives the first and second data D1 and D2 and outputs the first compensation signal CMPS1 based on the first and second data D1 and D2 is illustrated in FIG. 3, but the present disclosure is not limited thereto. For example, the phase synchronization circuit 300 may further include third data and may further output a second compensation signal CMPS2 based on the first data D1 and the third data. That is, the phase synchronization circuit 300 may generate a plurality of compensation signals being analog signals, based on a plurality of data being digital signals.

The phase synchronization circuit 300 may include a pre-processing circuit 310, a phase compensation circuit 330, a digital-to-analog converter (DAC) 350, a memory 370, and a control circuit 390.

The pre-processing circuit 310 may receive the first data D1 and the second data D2. The pre-processing circuit 310 may pre-process the first data D1 and the second data D2 and may generate pre-processed data.

In an embodiment, the pre-processing circuit 310 may generate the pre-processed data by quantizing the first data D1 and the second data D2, encoding the quantized first data D1 and the quantized second data D2, and performing a subtraction operation on the encoded first data D1 and the encoded second data D2.

In an embodiment, the pre-processed data may include coarse phase difference data CPDD roughly indicating a phase difference between the first data D1 and the second data D2 and fine phase difference data FPDD finely indicating a phase difference between the first data D1 and the second data D2. For example, some of bits of the pre-processed data may indicate the coarse phase difference data CPDD, and the others thereof may indicate the fine phase difference data FPDD.

In an embodiment, the pre-processing circuit 310 may output the coarse phase difference data CPDD to the memory 370 or a register (not illustrated) and may output the fine phase difference data FPDD to the phase compensation circuit 330.

The phase compensation circuit 330 may synchronize the phase of the second data D2 with the phase of the first data D1 based on the data received from the pre-processing circuit 310 and may output compensation data.

In an embodiment, the phase compensation circuit 330 may receive a plurality of fine phase difference data FPDD corresponding to a plurality of time points (e.g., a plurality of encoding time points) from the pre-processing circuit 310. The phase compensation circuit 330 may synchronize the phase of the second data D2 with the phase of the first data D1 based on the plurality of fine phase difference data FPDD and may output compensation data.

For example, the phase compensation circuit 330 may receive the plurality of fine phase difference data FPDD corresponding to the plurality of time points from the pre-processing circuit 310. The phase compensation circuit 330 may output a plurality of compensation data corresponding to the plurality of time points to the digital-to-analog converter 350, based on the plurality of fine phase difference data FPDD.

In an embodiment, the phase compensation circuit 330 may correct an error of compensation data. For example, the phase compensation circuit 330 may compare an error of compensation data with a preset threshold value. When a compensation result indicates that the error is within the threshold value, the phase compensation circuit 330 may correct the error so as to be output to the digital-to-analog converter 350. When a compensation result indicates that the error exceeds the threshold value, the phase compensation circuit 330 may again perform the pre-processing operation and the phase compensation operation.

The digital-to-analog converter 350 may convert the data output from the phase compensation circuit 330 and may generate an analog signal. For example, the digital-to-analog converter 350 may convert the compensation data output from the phase compensation circuit 330 and may generate the first compensation signal CMPS1 being an analog signal.

In an embodiment, the digital-to-analog converter 350 may generate the first compensation signal CMPS1, based on the plurality of compensation data corresponding to the plurality of time points.

The memory 370 may include a read only memory (ROM) or a random access memory (RAM). The memory 370 may store various information and data associated with a computational operation of the phase synchronization circuit 300. For example, the memory 370 may include a phase compensation table CMPTBL. The phase compensation table CMPTBL may include various information, which is necessary to synchronize the phase of the second data D2 with the phase of the first data D1, such as information about phase angles at a plurality of time points of the first data D1 being reference data, bit string information corresponding to the phase angles, and phase delay information associated with the phase angles.

In an embodiment, the phase compensation table CMPTBL may be stored in the ROM. Accordingly, when the phase compensation table CMPTBL is stored in the ROM, power consumption may be reduced compared to the case where the phase compensation table CMPTBL is stored in the RAM.

The control circuit 390 may control all the operations of the phase synchronization circuit 300. For example, the control circuit 390 may generate control signals for controlling the pre-processing circuit 310, the phase compensation circuit 330, the digital-to-analog converter 350, and the memory 370 and may transmit the control signals to the pre-processing circuit 310, the phase compensation circuit 330, the digital-to-analog converter 350, and the memory 370, respectively.

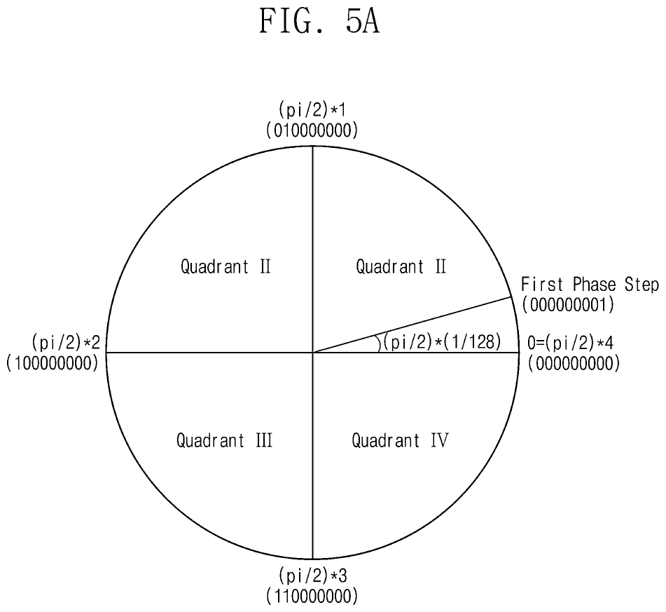

FIG. 4 illustrates an example of a pre-processing circuit of FIG. 3. Referring to FIGS. 3 and 4, the pre-processing circuit 310 may include a quantizer 311, an encoder 313, and a subtracter 315. The quantizer 311 may receive the first data D1 and the second data D2. The quantizer 311 may generate first quantized data QD1 and second quantized data QD2 based on the first data D1 and the second data D2. For example, the quantizer 311 may quantize the first data D1 to generate the first quantized data QD1 and may quantize the second data D2 to generate the second quantized data QD2.

In an embodiment, the first quantized data QD1 and the second quantized data QD2 may be data obtained by approximating the first data D1 and the second data D2 to a preset representative value.

The quantizer 311 may output the first quantized data QD1 and the second quantized data QD2 to the encoder 313.

The encoder 313 may receive the first quantized data QD1 and the second quantized data QD2 from the quantizer 311. The encoder 313 may generate first encoding data ED1 and second encoding data ED2 based on the first quantized data QD1 and the second quantized data QD2. For example, the encoder 313 may encode the first quantized data QD1 to generate the first encoding data ED1 and may encode the second quantized data QD2 to generate the second encoding data ED2.

In an embodiment, the encoder 313 may encode the first quantized data QD1 and the second quantized data QD2 such that the number of bits of the first quantized data QD1 and the second quantized data QD2 changes. For example, the encoder 313 may encode the first quantized data QD1 and the second quantized data QD2 such that the number of bits of the first encoding data QD1 and the second encoding data ED2 decreases.

The encoder 313 may output the first encoding data ED1 and the second encoding data ED2 to the subtracter 315.

The subtracter 315 may receive the first encoding data ED1 and the second encoding data ED2 from the encoder 313. The subtracter 315 may generate pre-processed data PRED based on the first encoding data ED1 and the second encoding data ED2.

In an embodiment, the subtracter 315 may generate the pre-processed data PRED based on the number of bits of the first encoding data ED1 and the second encoding data ED2. For example, the subtracter 315 may generate the pre-processed data PRED with the number of bits being identical to the number of bits of the first encoding data ED1 and the second encoding data ED2.

The pre-processed data PRED may include the coarse phase difference data CPDD and the fine phase difference data FPDD. The subtracter 315 may output the coarse phase difference data CPDD to the memory 370 of FIG. 3 and may output the fine phase difference data FPDD to the phase compensation circuit 330 of FIG. 3.

In an embodiment, the subtracter 315 may generate the pre-processed data PRED by performing the subtraction operation on the first encoding data ED1 and the second encoding data ED2.

In an embodiment, a first portion of the pre-processed data PRED may indicate the coarse phase difference data CPDD, and a second portion of the pre-processed data PRED may indicate the fine phase difference data FPDD. For example, when the pre-processed data PRED are m-bit data, “k” upper bits of the pre-processed data PRED may indicate the coarse phase difference data CPDD, and (m−k) lower bits of the pre-processed data PRED may indicate the fine phase difference data FPDD.

In an embodiment, the subtracter 315 may generate the pre-processed data PRED based on a portion of each of the first encoding data ED1 and the second encoding data ED2. For example, the subtracter 315 may generate the coarse phase difference data CPDD, based on a first portion of the first encoding data ED1 and a first portion of the second encoding data ED2. For example, the subtracter 315 may generate the fine phase difference data FPDD, based on a second portion of the first encoding data ED1 and a second portion of the second encoding data ED2.

In an embodiment, the pre-processing circuit 310 may pre-process the first data D1 and the second data D2 every time point (e.g., a sampling time point of each analog-to-digital converter of FIG. 1) and may generate the coarse phase difference data CPDD and the fine phase difference data FPDD for each time point.

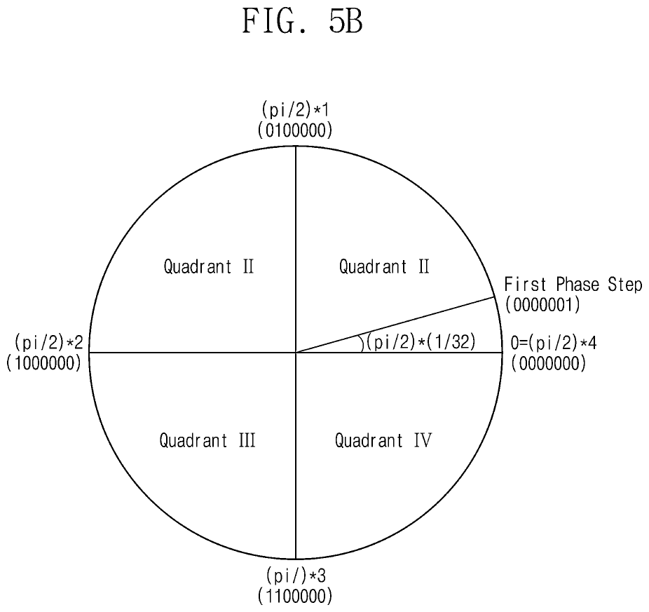

FIGS. 5A and 5B are diagrams for describing the pre-processed data PRED, according to an embodiment of the present disclosure. Referring to FIGS. 3 and 5A, a phase angle may be expressed by 9-bit data. In this case, phase angles may be classified into 512 phase steps, and an interval between adjacent phase angles may be a “(pi/2)*( 1/128)” radian. That is, the resolution of the phase synchronization circuit 300 may be about “0.7” degree. In FIG. 5A, a value of a bit string of data corresponding to a “0’ radian may be “000000000”, a value of a bit string of data corresponding to a “pi/2’ radian may be “010000000”, a value of a bit string of data corresponding to a “pi′ radian may be “100000000”, and a value of a bit string of data corresponding to a “3pi/2’ radian may be “110000000”. In FIG. 5A, a value of a bit string of data corresponding to a first phase step may be “000000001”, and a phase angle corresponding to the first phase step may be a “(pi/2)*( 1/128)” radian.

The pre-processed data PRED may correspond to one of the 512 phase steps. In FIG. 5A, the pre-processed data PRED may be expressed by 9-bit data. Two upper bits of the pre-processed data PRED may indicate the coarse phase difference data CPDD, and the remaining seven bits other than the two upper bits may indicate the fine phase difference data FPDD.

When the pre-processed data PRED exists in the first quadrant, a value of the bit string of the coarse phase difference data CPDD may be “00”. When the pre-processed data PRED exists in the second quadrant, a value of the bit string of the coarse phase difference data CPDD may be “01”. When the pre-processed data PRED exists in the third quadrant, a value of the bit string of the coarse phase difference data CPDD may be “10”. When the pre-processed data PRED exists in the fourth quadrant, a value of the bit string of the coarse phase difference data CPDD may be “11”.

The fine phase difference data FPDD may be repeated based on a “(pi/2)” radian. For example, when the pre-processed data PRED corresponds to the first phase step, the 129-th phase step, the 257-th phase step, or the 385-th phase step, a value of the bit string of the fine phase difference data FPDD may be “0000001”.

Referring to FIGS. 3, 4, and 5B, a phase angle may be expressed by 7-bit data. In this case, phase angles may be classified into 128 phase steps, and an interval between adjacent phase angles may be a “(pi/2)*( 1/32)” radian. That is, the resolution of the phase synchronization circuit 300 may be about “2.8” degrees. In FIG. 5B, a value of a bit string of data corresponding to a “0’ radian may be “0000000”, a value of a bit string of data corresponding to a “pi/2’ radian may be “0100000”, a value of a bit string of data corresponding to a “pi′ radian may be “1000000”, and a value of a bit string of data corresponding to a “3pi/2” radian may be “1100000”. In FIG. 5B, a value of a bit string of data corresponding to a first phase step may be “0000001”, and a phase angle corresponding to the first phase step may be a “(pi/2)*( 1/32)” radian.

The pre-processed data PRED may correspond to one of the 128 phase steps. In FIG. 5B, the pre-processed data PRED may be expressed by 9-bit data. Two upper bits of the pre-processed data PRED may indicate the coarse phase difference data CPDD, and the remaining five bits other than the two upper bits may indicate the fine phase difference data FPDD.

When the pre-processed data PRED exists in the first quadrant, a value of the bit string of the coarse phase difference data CPDD may be “00”. When the pre-processed data PRED exists in the second quadrant, a value of the bit string of the coarse phase difference data CPDD may be “01”. When the pre-processed data PRED exists in the third quadrant, a value of the bit string of the coarse phase difference data CPDD may be “10”. When the pre-processed data PRED exists in the fourth quadrant, a value of the bit string of the coarse phase difference data CPDD may be “11”.

The fine phase difference data FPDD may be repeated based on a “(pi/2)” radian. For example, when the pre-processed data PRED corresponds to the first phase step, the 33-th phase step, the 65-th phase step, or the 97-th phase step, a value of the bit string of the fine phase difference data FPDD may be “00001”.

As described with reference to FIGS. 5A and 5B, the coarse phase difference data CPDD may be determined based on the quadrant to which the pre-processed data PRED belongs. Accordingly, to simplify a computing process, the phase compensation circuit 330 of FIG. 3 may perform computation by using the fine phase difference data FPDD being a portion of the pre-processed data PRED, not the entire pre-processed data PRED. After performing computation, the phase compensation circuit 330 of FIG. 3 may refer to the coarse phase difference data CPDD.

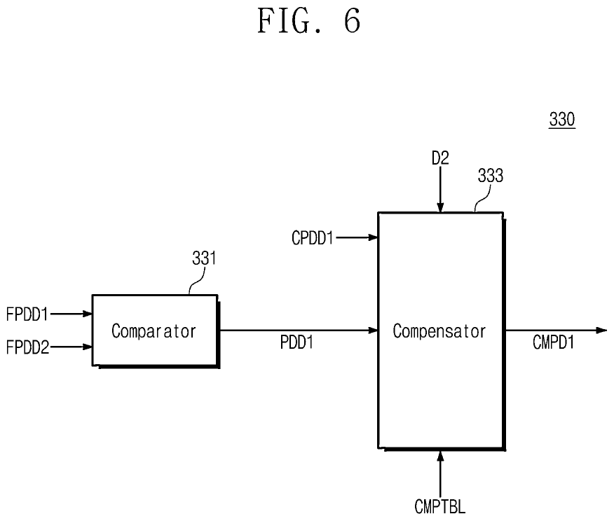

FIG. 6 illustrates an example of a phase compensation circuit of FIG. 3. Referring to FIGS. 3, 4, and 6, the phase compensation circuit 330 may include a comparator 331 and a compensator 333.

The comparator 331 may receive first fine phase difference data FPDD1 corresponding to a first time point and second fine phase difference data FPDD2 corresponding to a second time point from the subtracter 315. In an embodiment, the first time point may be an arbitrary time point, and the second time point may be a time point before the first time point. For example, the first time point may be an arbitrary sampling time point associated with the first data D1 and the second data D2, and the second time point may be a sampling time point immediately before the sampling time point corresponding to the first time point.

The comparator 331 may generate first phase difference data PDD1, based on the first fine phase difference data FPDD1 and the second fine phase difference data FPDD2. For example, the comparator 331 may compare the first fine phase difference data FPDD1 and the second fine phase difference data FPDD2 and may generate the first phase difference data PDD1 associated with the first time point. The comparator 331 may output the first phase difference data PDD1 to the compensator 333.

In an embodiment, the first phase difference data PDD1 may indicate a difference in phase differences between the first data D1 and the second data D2 at different time points. For example, the first phase difference data PDD1 may indicate a difference between the fine phase difference of the first data D1 and second data D2 at the first time point and the fine phase difference of the first data D1 and second data D2 at the second time point.

The compensator 333 may compensate the phase of the second data D2 associated with the first time point, based on the first phase difference data PDD1, coarse phase difference data CPDD1 corresponding to the first time point, and the phase compensation table CMPTBL and may output first compensation data CMPD1.

In an embodiment, the phase compensation table CMPTBL may include information about phase angles of the first data D1 (i.e., reference data) at a plurality of time points, bit string information corresponding to the phase angles, phase delay information associated with the phase angles, information about the number of bits of the pre-processed data PRED, etc. However, the present disclosure is not limited thereto. For example, the phase compensation table CMPTBL may include various information necessary to compensate for the phase of the second data D2.

In an embodiment, the compensator 333 may search for a compensation delay corresponding to the first phase difference data PDD1 and the first coarse phase difference data CPDD1 by referring to the phase compensation table CMPTBL. For example, the compensator 333 may combine the first phase difference data PDD1 and the first coarse phase difference data CPDD1 and may search for a compensation delay corresponding to the combined data. For example, the compensator 333 may combine “10” being a value of a bit string of the first coarse phase difference data CPDD1 and “11111” being a value of a bit string of the first phase difference data PDD1 and may search for a compensation delay corresponding to “1011111” being the combined data. In an embodiment, the compensator 333 may compensate for the second data D2 based on the found compensation delay. For example, the compensator 333 may compensate for the second data D2 corresponding to the first time point based on the found compensation delay and may output the first compensation data CMPD1 corresponding to the first time point.

In an embodiment, the phase compensation table CMPTBL may be stored in the memory 370. In an embodiment, the phase compensation table CMPTBL may be stored in the ROM of the memory 370.

In an embodiment, the first coarse phase difference data CPDD1 may be stored in the memory 370 or a register (not illustrated).

An example in which the phase compensation circuit 330 outputs the first compensation data CMPD1 associated with the first time point is illustrated in FIG. 6, but the present disclosure is not limited thereto. For example, the phase compensation circuit 330 may repeatedly perform the operations described with reference to FIG. 6 and may output a plurality of compensation data associated with a plurality of time points.

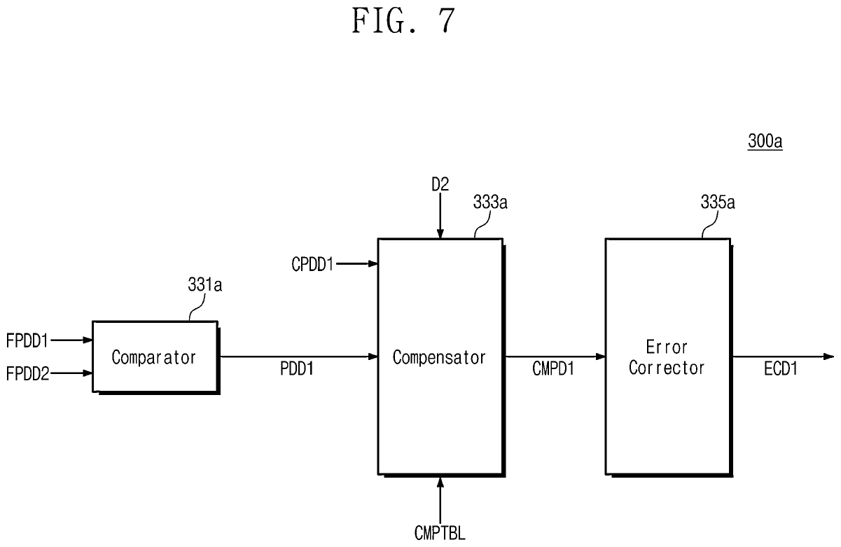

FIG. 7 illustrates another example of a phase compensation circuit of FIG. 3. Referring to FIG. 7, a phase synchronization circuit 300a may include a comparator 331a, a compensator 333a, and an error corrector 335a. Operations of the comparator 331a and the compensator 333a of FIG. 7 are the same as the operations of the comparator 331 and the compensator 333 of FIG. 6. Thus, additional description will be omitted to avoid redundancy.

The error corrector 335a may receive the first compensation data CMPD1 from the compensator 333a. The error corrector 335a may correct an error of the first compensation data CMPD1 and may generate first error correction data ECD1.

In an embodiment, the error of the first compensation data CMPD1 may mean a difference between a phase angle of the first compensation data CMPD1 and phase angles of phase steps adjacent to the phase angle of the first compensation data CMPD1. For example, when the phase angle of the first compensation data CMPD1 is included in a zone between the first phase step and the second phase step, the error of the first compensation data CMPD1 may mean a difference between the phase angles of the first compensation data CMPD1 and the first phase step or a difference between the phase angles of the first compensation data CMPD1 and the second phase step.

In an embodiment, the error corrector 335a may determine whether to correct the error of the first compensation data CMPD1 based on a preset threshold value.

For example, when the error of the first compensation data CMPD1 is within the threshold value, the error corrector 335a may correct the error of the first compensation data CMPD1.

For example, when the error of the first compensation data CMPD1 exceeds the threshold value, the phase synchronization circuit 300 of FIG. 3 may again perform the pre-processing operation and the phase compensation operation.

In an embodiment, when the error of the first compensation data CMPD1 exceeds the threshold value, the pre-processing circuit 310 may encode the first data D1 and the second data D2 such that the number of bits of the pre-processed data PRED changes. For example, when the error of the first compensation data CMPD1 exceeds the threshold value, the error corrector 335a may transmit a result signal to the control circuit 390 of FIG. 3. The control circuit 390 may transmit a re-execution signal to the pre-processing circuit 310 and the phase compensation circuit 330 in response to receiving the result signal. In response to receiving the re-execution signal, the pre-processing circuit 310 may encode the first data D1 and the second data D2 such that the number of bits of the pre-processed data PRED changes.

The error corrector 335a may output the first error correction data ECD1. In an embodiment, when an error is absent from the first compensation data CMPD1, the error corrector 335a may output the first compensation data CMPD1 as the first error correction data ECD1 without modification.

An example in which the phase compensation circuit 300a outputs the first error correction data ECD1 associated with the first time point is illustrated in FIG. 7, but the present disclosure is not limited thereto. For example, the phase compensation circuit 300a may repeatedly perform the operations described with reference to FIG. 7 and may output a plurality of error correction data associated with a plurality of time points.

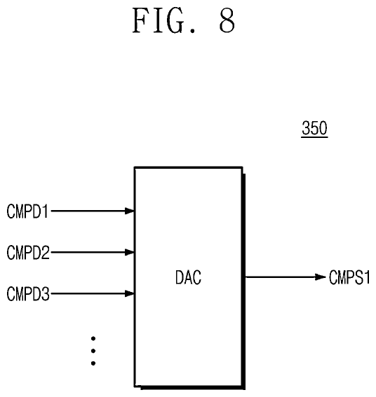

FIG. 8 illustrates the digital-to-analog converter 350 of FIG. 3. The first compensation data CMPD1 of FIG. 8 may correspond to the first compensation data CMPD1 of FIG. 6.

Referring to FIGS. 3 and 8, the digital-to-analog converter 350 may receive the first compensation data CMPD1 associated with the first time point, second compensation data CMPD2 associated with a second time point, and third compensation data CMPD3 associated with a third time point. In an embodiment, the first time point, the second time point, and the third time point may be three time points which are successive.

The digital-to-analog converter 350 may synchronize the phase of the second data D2 with the phase of the first data D1 based on the first to third compensation data CMPD1, CMPD2, and CMPD3 and may output the first compensation signal CMPS1.

For example, the digital-to-analog converter 350 may output the first compensation signal CMPS1 being an analog signal, based on information included in the first to third compensation data CMPD1, CMPD2, and CMPD3 being digital signals.

An example in which the digital-to-analog converter 350 receives the first to third compensation data CMPD1, CMPD2, and CMPD3 is illustrated in FIG. 8, but the digital-to-analog converter 350 may receive the first to third error correction data ECD1, ECD2, and ECD3.

In an embodiment, the digital-to-analog converter 350 may receive the first error correction data ECD1 associated with the first time point, the second error correction data ECD2 associated with the second time point, and the third error correction data ECD3 associated with the third time point.

In an embodiment, the digital-to-analog converter 350 may synchronize the phase of the second data D2 with the phase of the first data D1 based on the first to third error correction data ECD1, ECD2, and ECD3 and may output the first compensation signal CMPS1.

For example, the digital-to-analog converter 350 may output the first compensation signal CMPS1 being an analog signal, based on information included in the first to third error correction data ECD1, ECD2, and ECD3 being digital signals.

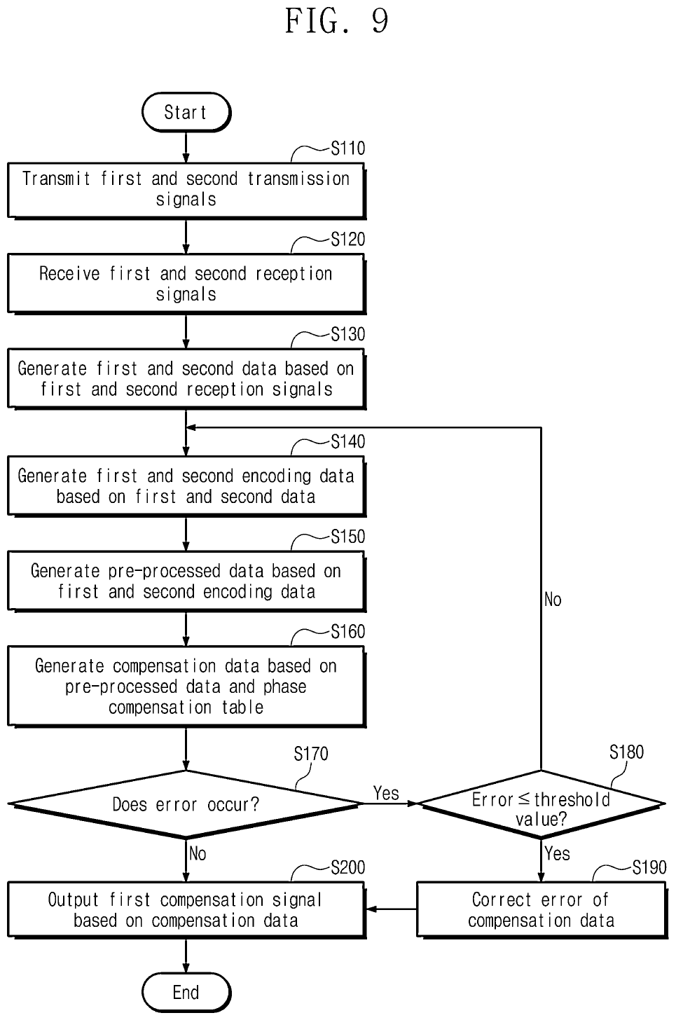

FIG. 9 illustrates an example of an operation of a radar device, according to an embodiment of the present disclosure. Referring to FIGS. 2 and 9, in operation S110, the radar device 200 may transmit the first and second transmission signals TS1 and TS2. For example, the radar device 200 may transmit the first and second transmission signals TS1 and TS2 to a target through the first and second transmitting antennas 231_1 and 231_2.

In operation S120, the radar device 200 may receive the first and second reception signals RS1 and RS2. For example, the radar device 200 may receive the first and second reception signals RS1 and RS2 through the first and second receiving antennas 251_1 and 251_2.

In operation S130, the radar device 200 may generate the first and second data D1 and D2 based on the first and second reception signals RS1 and RS2. For example, the radar device 200 may amplify the first and second reception signals RS1 and RS2. The radar device 200 may convert the amplified first and second reception signals RS1 and RS2 and may generate the first and second data D1 and D2 being digital signals

In operation S140, the radar device 200 may generate the first and second encoding data ED1 and ED2 based on the first and second data D1 and D2. For example, the radar device 200 may quantize the first and second data D1 and D2 and may generate the first and second quantized data QD1 and QD2. The radar device 200 may encode the first and second quantized data QD1 and QD2 and may generate the first and second encoding data ED1 and ED2.

In operation S150, the radar device 200 may generate the pre-processed data PRED based on the first and second encoding data ED1 and ED2. For example, the subtracter 200 may generate the pre-processed data PRED by performing the subtraction operation on the first and second encoding data ED1 and ED2.

In operation S160, the radar device 200 may generate compensation data CMPD based on the pre-processed data PRED and the phase compensation table CMPTBL.

In operation S170, the radar device 200 may determine whether an error is present in the compensation data CMPD. When the error is present in the compensation data CMPD, in operation S180, the radar device 200 may determine whether the error is within a threshold value. When the error is absent from the compensation data CMPD, in operation S200, the radar device 200 may generate the first compensation signal CMPS1 being an analog signal, based on the compensation data CMPD.

Returning to operation S180, when the error is within the threshold value, the radar device 200 may correct the error of the compensation data CMPD in operation S190 and may generate the first compensation signal CMPS1 based on the error-corrected compensation data CMPD in operation S200. When the error exceeds the threshold value, in operation S140, the radar device 200 may generate the first and second encoding data ED1 and ED2, in which the number of bits is changed, based on the first and second data D1 and D2. Afterwards, the radar device 200 may repeatedly perform operation S150 to operation S170.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

According to the present disclosure, a radar device may synchronize phases of various radar signals with a phase of a reference signal in a digital domain. Accordingly, the radar device may improve coherence of a distributed radar device by synchronizing phases of radar signals without limitation on a driving method.

According to the present disclosure, because a radar device performs computation for a portion of data, the burden of computation of the radar device may decrease, and a computational speed may be improved.

According to the present disclosure, because the radar device has no limitation in a driving method, the radar device may be utilized to detect and rescue a human efficiently in a disaster environment.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A radar device comprising:
a transmission circuit configured to emit a first transmission signal and a second transmission signal; and
a reception circuit configured to receive a first reception signal associated with the first transmission signal and a second reception signal associated with the second transmission signal, to convert the first reception signal into first data, and to convert the second reception signal into second data,
wherein the reception circuit synchronizes a phase of the second reception signal with a phase of the first reception signal based on the first data and the second data and outputs a first compensation signal, and
wherein the reception circuit includes:
a pre-processing circuit configured to generate first encoding data based on the first data, to generate second encoding data based on the second data, and to generate pre-processed data based on the first encoding data and the second encoding data;
a phase compensation circuit configured to generate compensation data based on the pre-processed data and a phase compensation table; and
a digital-to-analog converter configured to output the first compensation signal being an analog signal, based on the compensation data.

2. The radar device of claim 1, wherein the pre-processing circuit includes:
a quantizer configured to generate first quantized data and second quantized data based on the first data and the second data;
an encoder configured to generate the first encoding data and the second encoding data based on the first quantized data and the second quantized data; and
a subtracter configured to generate the pre-processed data by performing a subtraction operation on the first encoding data and the second encoding data,
wherein a first portion of the pre-processed data is coarse phase difference data, and
wherein a second portion of the pre-processed data is fine phase difference data.

3. The radar device of claim 2, wherein the subtracter generates first pre-processed data corresponding to a first time point and second pre-processed data corresponding to a second time point before the first time point, and
wherein the subtracter outputs first fine phase difference data being a second portion of the first pre-processed data and second fine phase difference data being a second portion of the second pre-processed data to the phase compensation circuit.

4. The radar device of claim 3, wherein the phase compensation circuit includes:
a comparator configured to perform a comparison operation on the first fine phase difference data and the second fine phase difference data and to generate first phase difference data associated with the first time point; and
a compensator configured to generate first compensation data associated with the first time point, based on the first phase difference data, first coarse data being a first portion of the first pre-processed data, and the phase compensation table.

5. The radar device of claim 4, wherein the compensator is configured to:
combine the first phase difference data and the first coarse data;
search the phase compensation table for the combined data; and
generate the first compensation data based on the found result.

6. The radar device of claim 4, wherein the compensator generates second compensation data associated with a third time point after the first time point, and
wherein the digital-to-analog converter outputs the first compensation signal, based on the first compensation data and the second compensation data.

7. The radar device of claim 4, wherein the phase compensation circuit further includes:
an error corrector configured to correct an error of the first compensation data.

8. The radar device of claim 7, wherein the error corrector is configured to:
compare the error and a preset threshold value; and
when the comparison result indicates that the error is within the threshold value, correct the error.

9. The radar device of claim 8, wherein the reception circuit includes:
a control circuit configured to control operations of the pre-processing circuit and the phase compensation circuit,
wherein, when the comparison result indicates that the error exceeds the threshold value, the error corrector transmits a result signal to the control circuit, and
wherein the control circuit receives the result signal and then transmits a re-execution signal to the pre-processing circuit.

10. The radar device of claim 9, wherein the pre-processing circuit receives the re-execution signal and then changes the number of bits of the first encoding data and the second encoding data.

11. The radar device of claim 1, wherein the phase compensation table is stored in a read only memory (ROM) included in the reception circuit.

12. The radar device of claim 1, wherein the second reception signal is one of a pulse signal, a continuous wave signal, and a frequency modulation continuous wave signal.

13. The radar device of claim 1, wherein the transmission circuit emits a third transmission signal, and
wherein the reception circuit is configured to:
receive a third reception signal associated with the third transmission signal;
convert the third reception signal into third data; and
synchronize a phase of the third reception signal with the phase of the first reception signal based on the first data and the third data and output a second compensation signal.

14. The radar device of claim 13, wherein the second reception signal and the third reception signal are two signals different from each other from among a pulse signal, a continuous wave signal, and a frequency modulation continuous wave signal.

15. An operation method of a radar device, the method comprising:
receiving a first reception signal associated with a first transmission signal and a second reception signal associated with a second transmission signal;
converting the first reception signal and the second reception signal into first data and second data;
generating first encoding data and second encoding data based on the first data and the second data;
generating pre-processed data based on the first encoding data and the second encoding data;
generating compensation data based on the pre-processed data and a phase compensation table; and
outputting a first compensation signal based on the compensation data.

16. The method of claim 15, wherein the generating of the first encoding data and the second encoding data includes:
generating first quantized data and second quantized data based on the first data and the second data,
wherein the generating of the pre-processed data includes:
performing a subtraction operation on the first encoding data and the second encoding data,
wherein a first portion of the pre-processed data is coarse phase difference data, and
wherein a second portion of the pre-processed data is fine phase difference data.

17. The method of claim 16, wherein the generating of the pre-processed data includes:
generating first pre-processed data corresponding to a first time point; and
generating second pre-processed data corresponding to a second time point before the first time point,
wherein the generating of the compensation data includes:
generating first phase difference data associated with the first time point by performing a comparison operation on first fine phase difference data being a second portion of the first pre-processed data and second fine phase difference data being a second portion of the second pre-processed data; and
generating first compensation data associated with the first time point, based on the first phase difference data, first coarse data being a first portion of the first pre-processed data, and the phase compensation table.

18. The method of claim 17, wherein the generating of the first compensation data includes:
combining the first phase difference data and the first coarse data;
searching the phase compensation table for the combined data; and
generating the first compensation data based on the found result.

19. The method of claim 17, wherein the generating of the compensation data includes:
generating second compensation data associated with a third time point after the first time point, and
wherein the outputting of the first compensation signal includes:
outputting the first compensation signal, based on the first compensation data and the second compensation data.

20. The method of claim 17, further comprising:
correcting an error of the first compensation data.
